(19) United States
(12) Patent Application Publication
(10) Pub. No.: US 2014/0320630 A1
(43) Pub. Date: Oct. 30, 2014

(54) DEVICE FOR AN AUTOMOBILE FUEL INTAKE CATALYTIC SYSTEM TEST AND ITS TEST METHOD

(71) Applicant: MIT AUTOMOBILE SERVICE COMPANY LIMITED, Yantai (CN)

(72) Inventors: ZHIXIN XIAO, Yantai (CN); Qin Wei, Yantai (CN); Zhiliang Wei, Yantai (CN); Qinglu Cui, Yantai (CN)

(73) Assignee: MIT AUTOMOBILE SERVICE COMPANY LIMITED, Yantai (CN)

(21) Appl. No.: 14/264,661

(22) Filed: Apr. 29, 2014

(30) Foreign Application Priority Data
Apr. 27, 2013 (CN) 20131015245.5

(51) Int. Cl. G01M 15/02

(52) U.S. Cl. CPC G01M 15/02
USPC 348/82

(57) ABSTRACT

This invention is a method to prevent excessive maintenance to vehicle lubricating system based on detection, to overcome the defect in maintenance procedure. The method prevents excessive maintenance to vehicle lubricating system based on detection, with oil detection module and host controller. Its working principle is to detect the aging degree of lube before maintenance, and decide whether to change the lube according to detection result. It will help to prevent excessive maintenance, reduce maintenance cost for car owners, and decrease the waste of resource. Oil detection module includes oil chamber sensor, capacitance detection chip, and etc. Host controller is connected to oil detection module by cables.

### FIELD OF THE INVENTION

This invention is the test equipment for automobile fuel/intake/catalytic system and its test method. Specifically, it is a new test equipment for automobile fuel/intake/catalytic system with new structure and realizing method for test function.

### BACKGROUND

The automobile industry has been increasing for many years worldwide. According to the driving restriction the fuel combustion may be insufficient, the carbon deposition might be on the top of the piston, intake valve, throttle body, and etc. More carbon deposition will take more oil consumption, even shut down the vehicle and damage the engine.

There's no specific equipment on the market to test the carbon deposition condition to certain vehicle areas. We can only judge the driving mileage or time to clear the carbon deposition. Car dealers will not be trusted if it cannot give trustworthy test results to car owners. This invention will show the carbon deposition condition in fuel/intake/catalytic system with images and comparison report, which will be definitely convincible.

### SUMMARY OF THE INVENTION

This invention provides the equipment for automobile fuel/intake/catalytic system and test method, resolving the judgment without test result. This invention is a method to prevent excessive maintenance to vehicle lubricating system based on detection, to overcome the defect in maintenance procedure. The method prevents excessive maintenance to vehicle lubricating system based on detection, with oil detection module and host controller. Its working principle is to detect the aging degree of lube before maintenance, and decide whether to change the lube according to detection result. It will help to prevent excessive maintenance, reduce maintenance cost for car owners, and decrease the waste of resource. Oil detection module includes oil chamber sensor, capacitance detection chip, and etc. Host controller is connected to oil detection module by cables.

This equipment for fuel/intake/catalytic system includes an endoscope kit, a 12″ LCD screen and a 7″ touchable LCD screen. The endoscope outputs the CVBS signal to 12″ LCD screen, through which images can be seen. The images can be also transmitted to 4S reception computer by Bluetooth and printed out.

A user operates the touch screen to get a fuel/intake/catalytic system standard image. The user can easily find the carbon deposition by comparing the images. The images can be updated and uploaded easily by GPRD module. Images can also be saved to a persistent memory.

The S3C2440 ARM main chip is applied on the equipment circuit board, with operating system Windows CE5.0. The 7″ LCD touchable screen is connected with the S3C2440 touch screen controller processor by 4 PIN FPC and connected with the LCD controlling joint/junction with 40 Pin FPC. The videos and images that endoscope gather are converted to a digital signal converted by the 7113 video switch chip, and then connected with the S3C2440 processor. The S3C2440 touch screen controller processor will control the 7113 video switch chip by IIC port to enable image capture capability. The Bluetooth module connects to the USB Host port of S3C2440. The Bluetooth module functionality is added during operation system compiling, to enable functions such as research, match, transfer and the like by API function in the software.

The GPRS module connects with the S3C2440 by serial port. Compiling software allows enabling transmission of the serial port data to the GPRS module by the S3C2440 processor, including proceeding with port configuration, data communication, GPRS image data and related functionalities.

The implement method of the test function includes the steps below.
a. Switch on the equipment, the software will automatically run, background will connect the GPRS, search whether there's new standard images, and download if there's any.
b. After the application program runs, enter into the vehicle model selection interface. From there select the vehicle brand, model and manufacturing year, then the standard image interface will come out. Standard images of different areas can be selected such as standard images on top of the piston for fuel system test, throttle body for intake system test. All these standard images will be shown onto the 7″ LCD screen.
c. Place the endoscope to the testing place then its image will be displayed on the 12″ LCD screen. The carbon deposition conditions image and standard image will be displayed onto two screen.
d. Click “Transmit image’ on the 7” LCD, then the system will match the Bluetooth, and transmit the images to computer with Bluetooth in 4S reception. Then the test image and standard images can be printed out.

The objects of this invention are detailed below.
1. The carbon deposition conditions on the top of the piston, intake valve, throttle body, and related parameters can be easily tested, displayed onto the screen and printed out.
2. This system avoids the disadvantages of judging the carbon deposition conditions by mileage or driving time. It avoids repeat maintenance or non-maintenance to harm the vehicle.

### BRIEF DESCRIPTION OF THE DRAWINGS

FIG. 1 Equipment electronic diagram.

FIG. 2a First ARM core-board schematic (diagram 1).

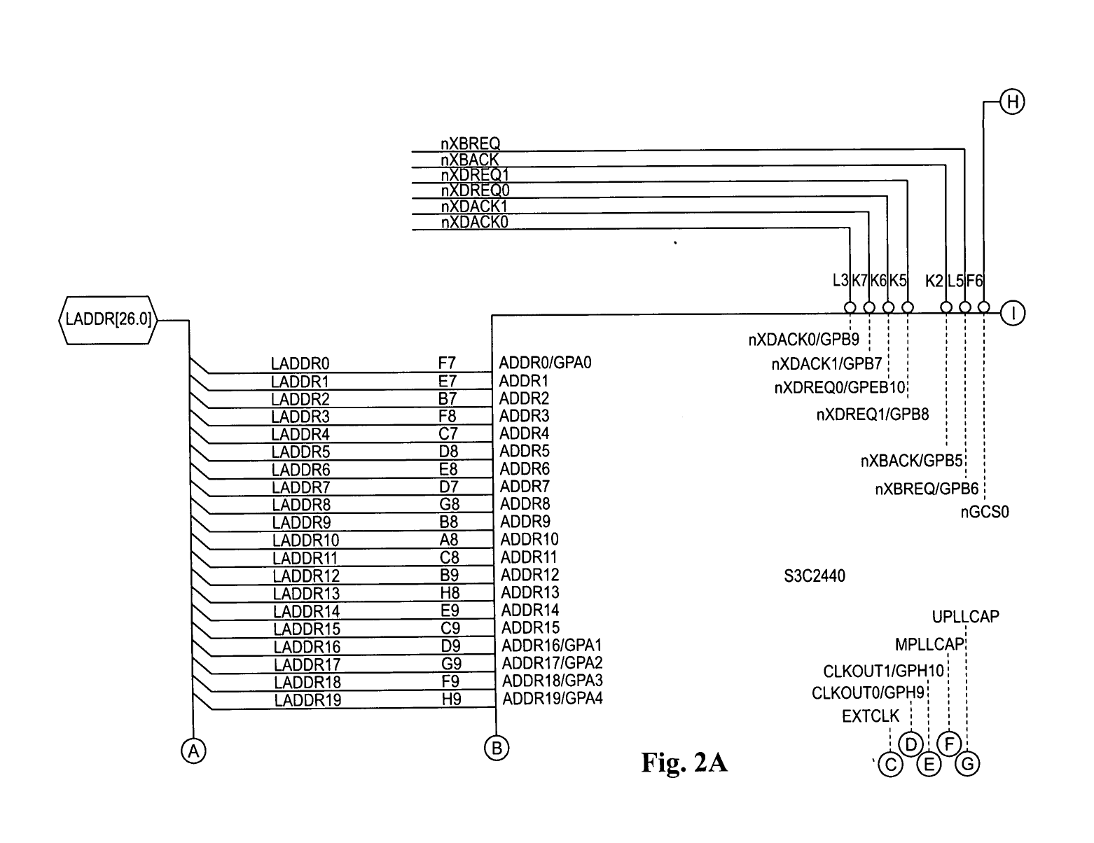

FIG. 2b First ARM core-board schematic (diagram 1).

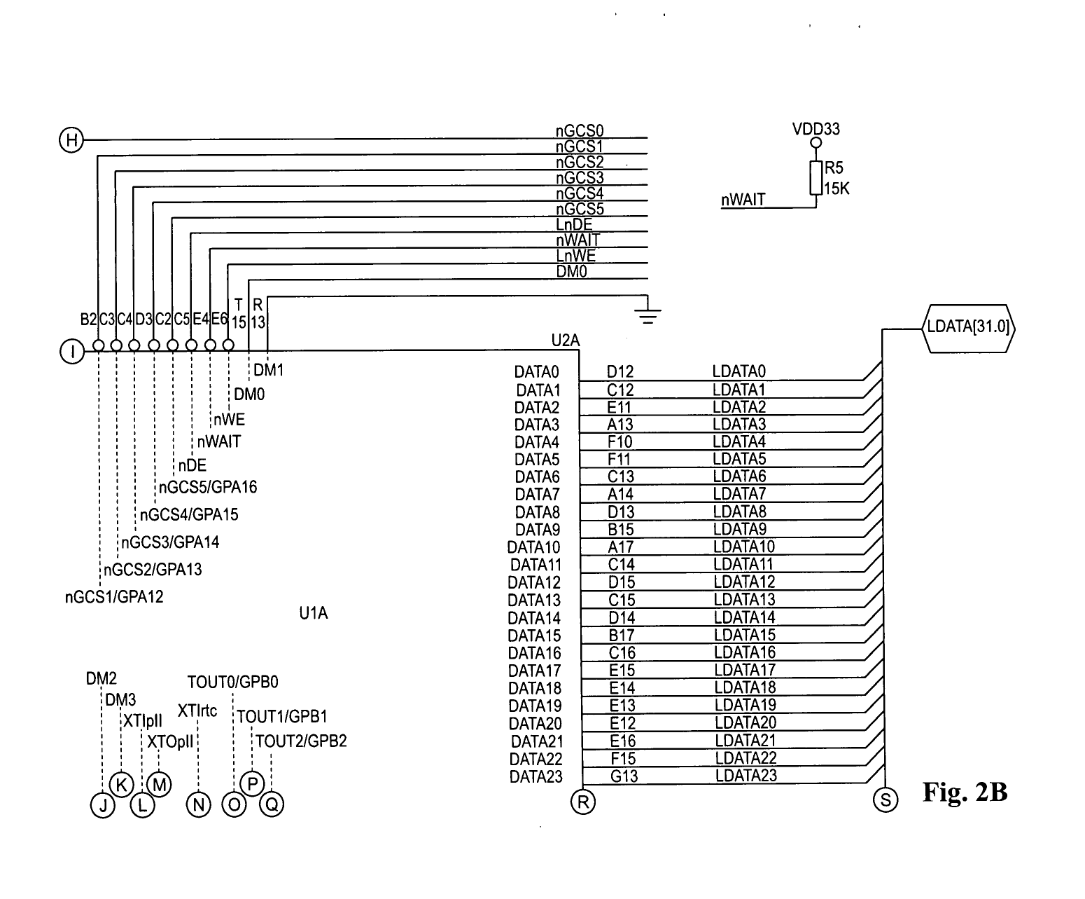

FIG. 2c First ARM core-board schematic (diagram 1).

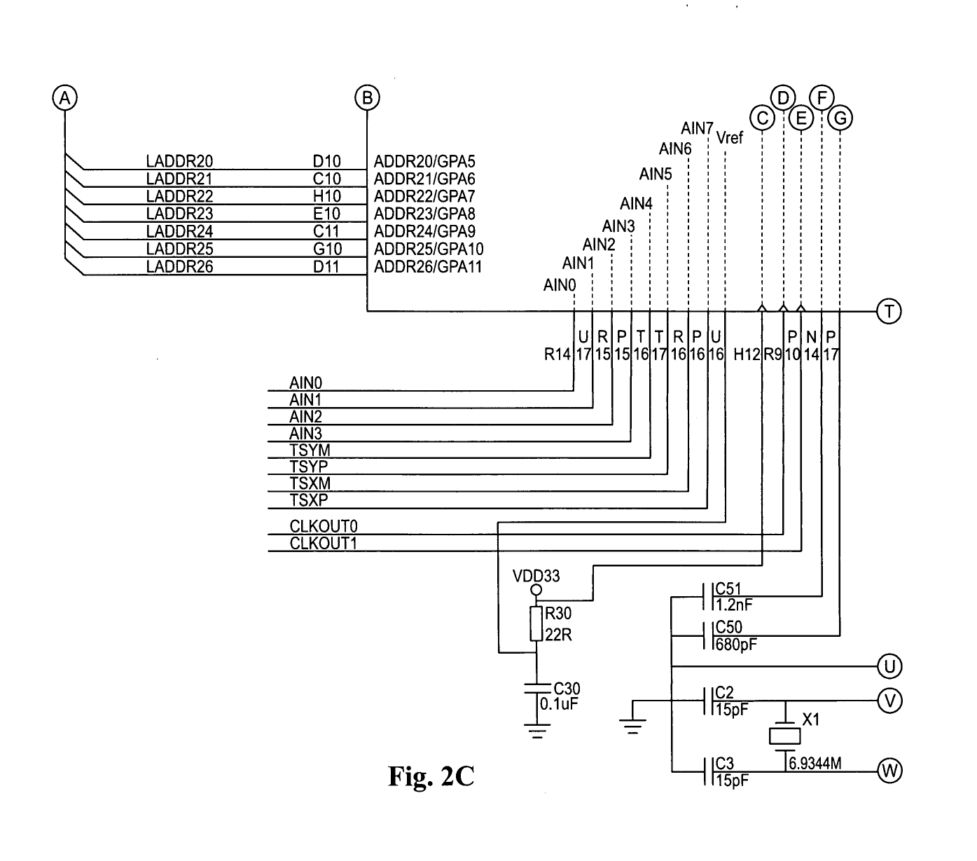

FIG. 2d First ARM core-board schematic (diagram 1).

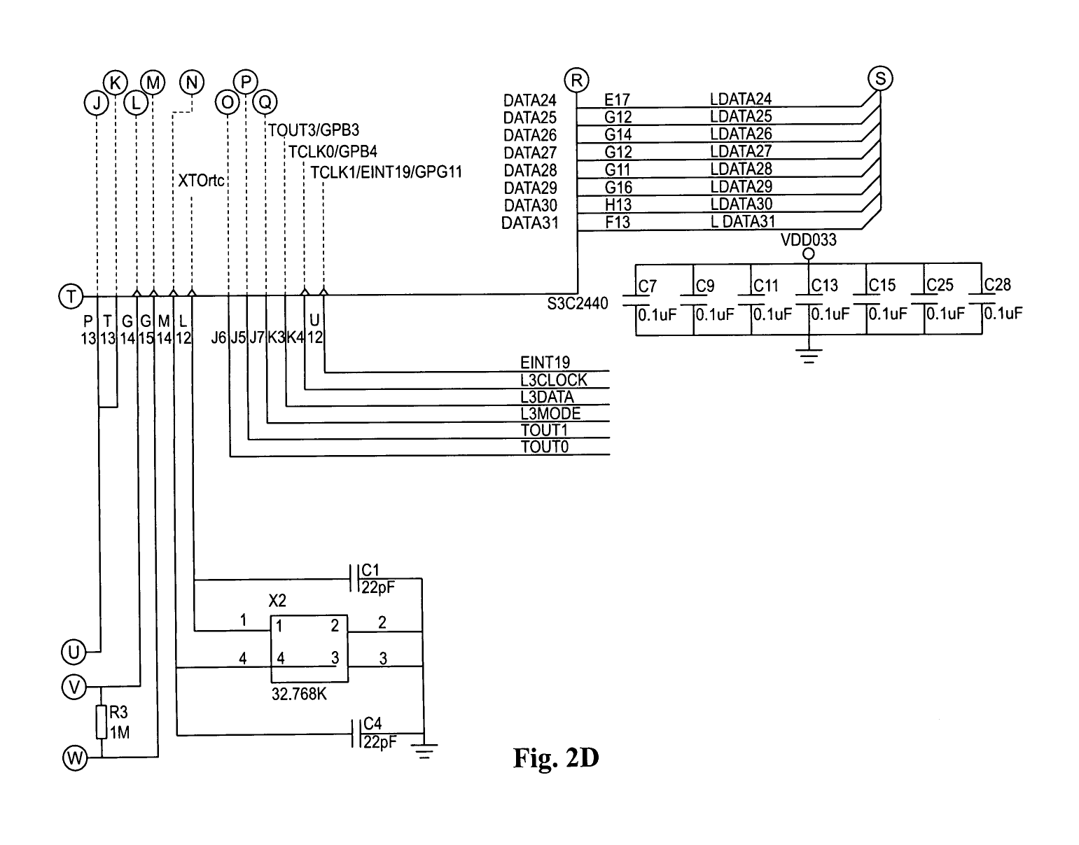

FIG. 3 Second ARM core-board schematic (diagram 2).

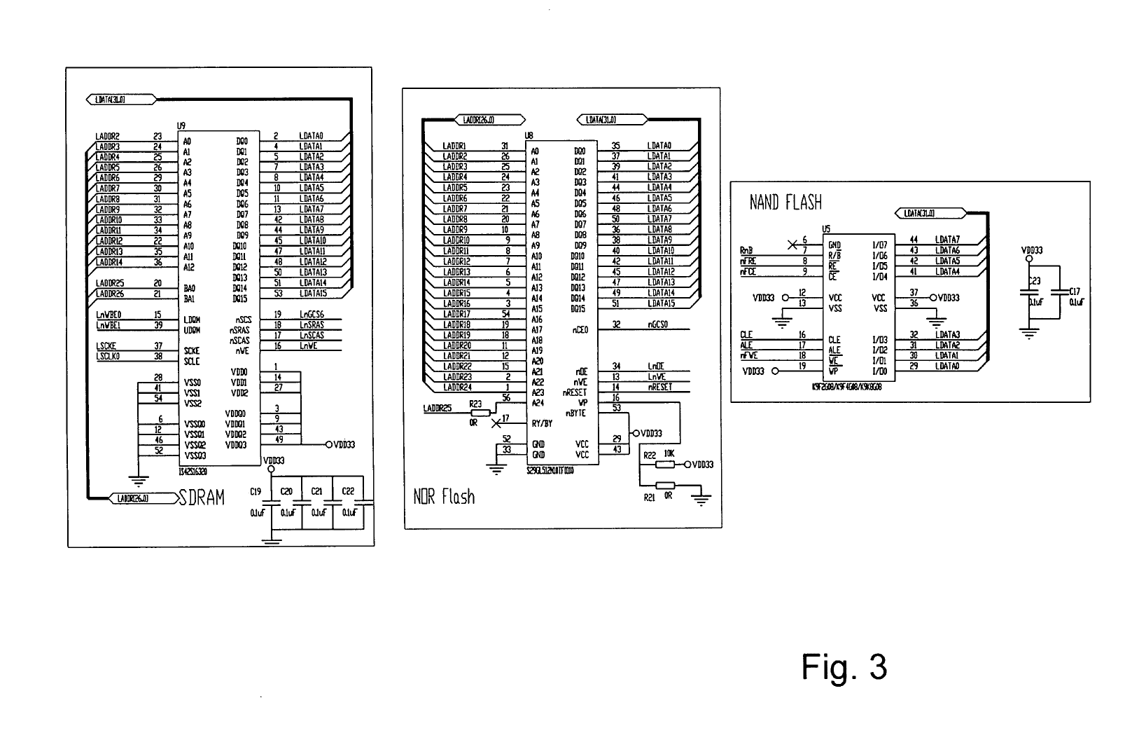

FIG. 4a First equipment outside baseboard schematic (diagram 1).

FIG. 4b First equipment outside baseboard schematic (diagram 1).

FIG. 4c First equipment outside baseboard schematic (diagram 1).

FIG. 4d First equipment outside baseboard schematic (diagram 1).

FIG. 5 Second equipment outside baseboard schematic (diagram 2).

The following call out list of elements can be a useful guide in referencing the elements of the drawings.
1 S3C2440
2 7113 video converting chip
3 SDRAM memory chip
4 NAND Flash memory chip
5 NOR Flash memory chip
6 Outside Baseboard
7 Endoscope
8 12″ LCD
9 7″ LCD touchable screen
10 Outside baseboard
11 GPRS Module

### DETAILED DESCRIPTION OF THE PREFERRED EMBODIMENT

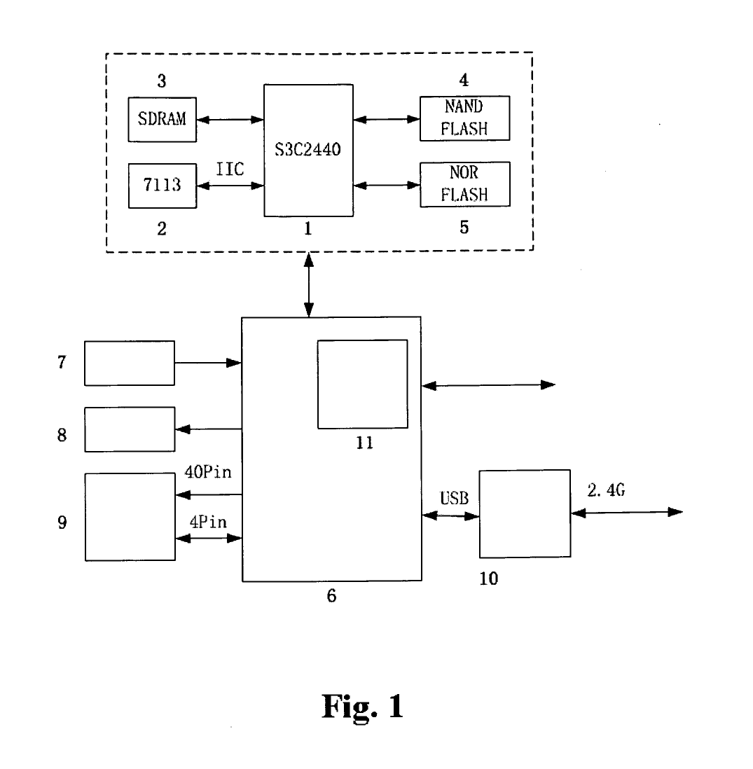

According to FIG. 1, the test equipment for automobile fuel/intake/catalytic system, S3C2440 1, 7113 video converting chip 2, SDRAM memory chip 3, NAND FLASH memory chip 4, NOR FLASH memory chip 5 consist of ARM core-board. ARM core-board is connecting with outside baseboard 6, see the schematic diagram 2 and 3. NOR FLASH memory chip 5 will store bootloader start-up file and osfile, NAND FLASH memory chip 4 will store standard image, SDRAM memory chip 3 will be used for OS temporary memory storage after the system is starting up.

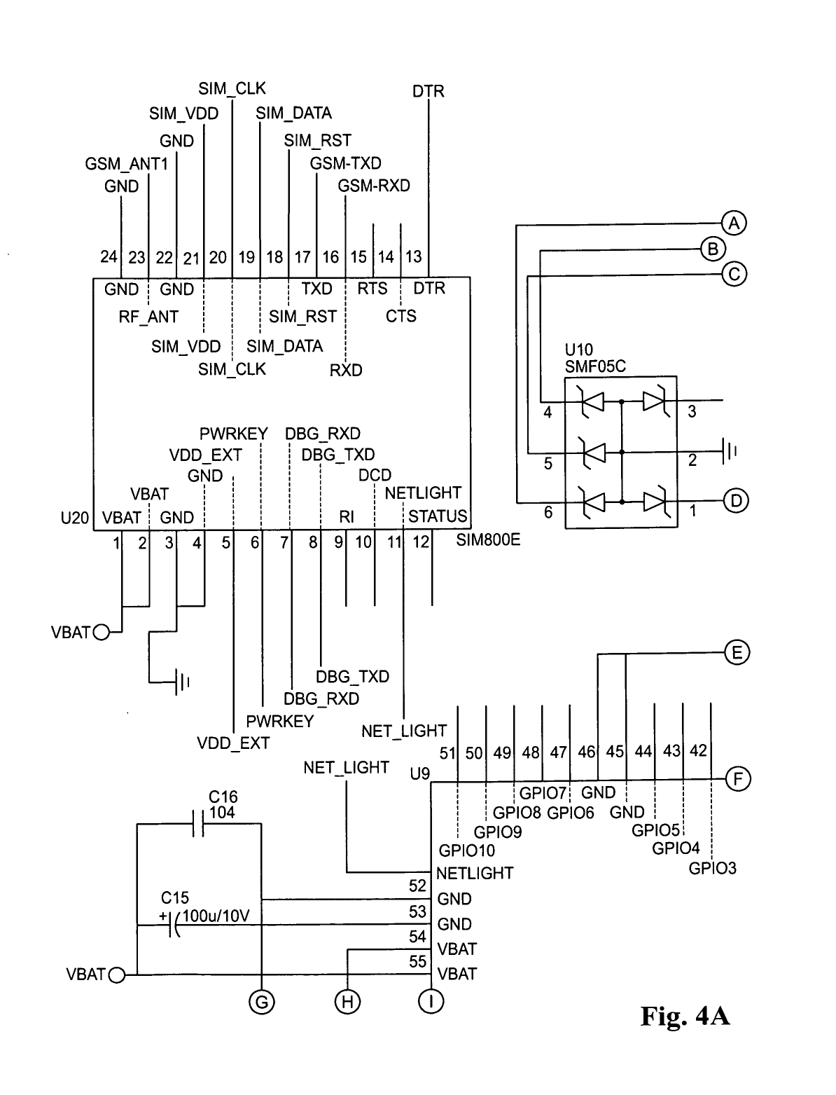

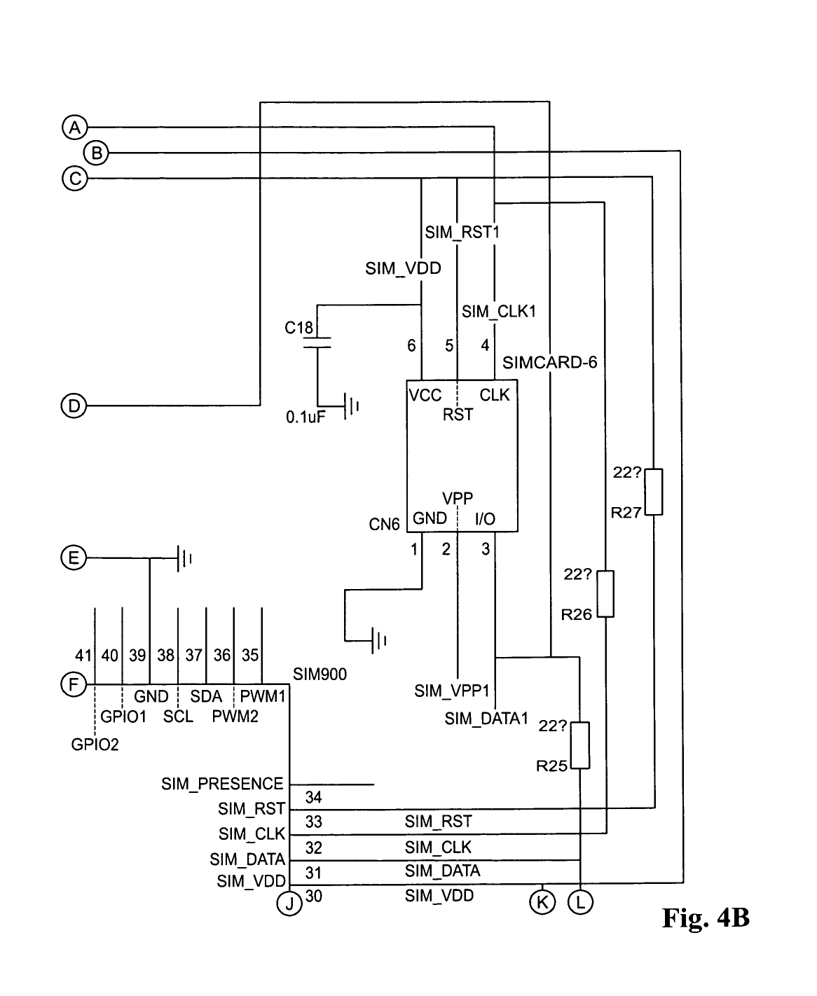

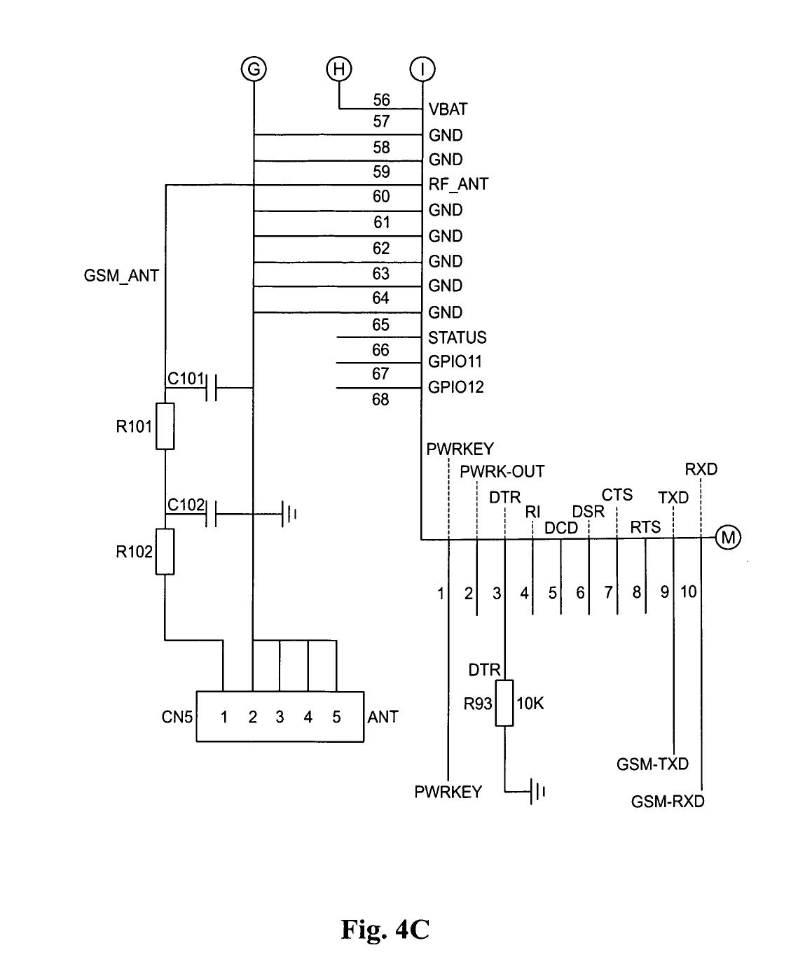

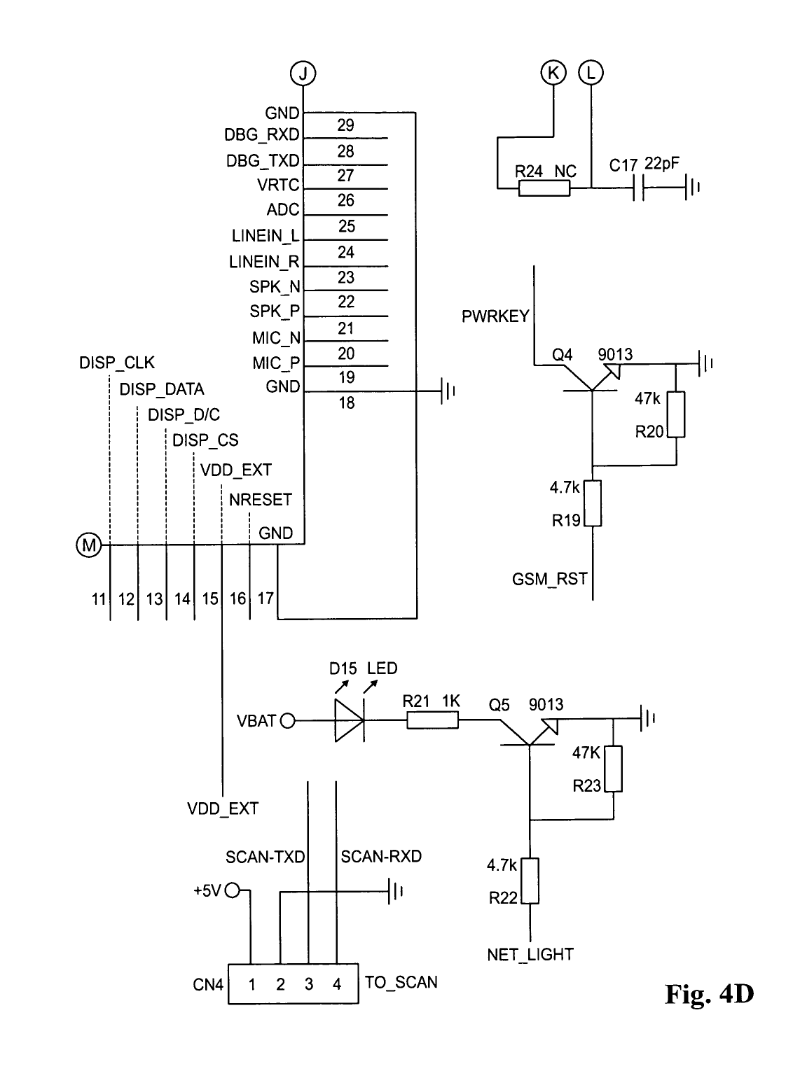

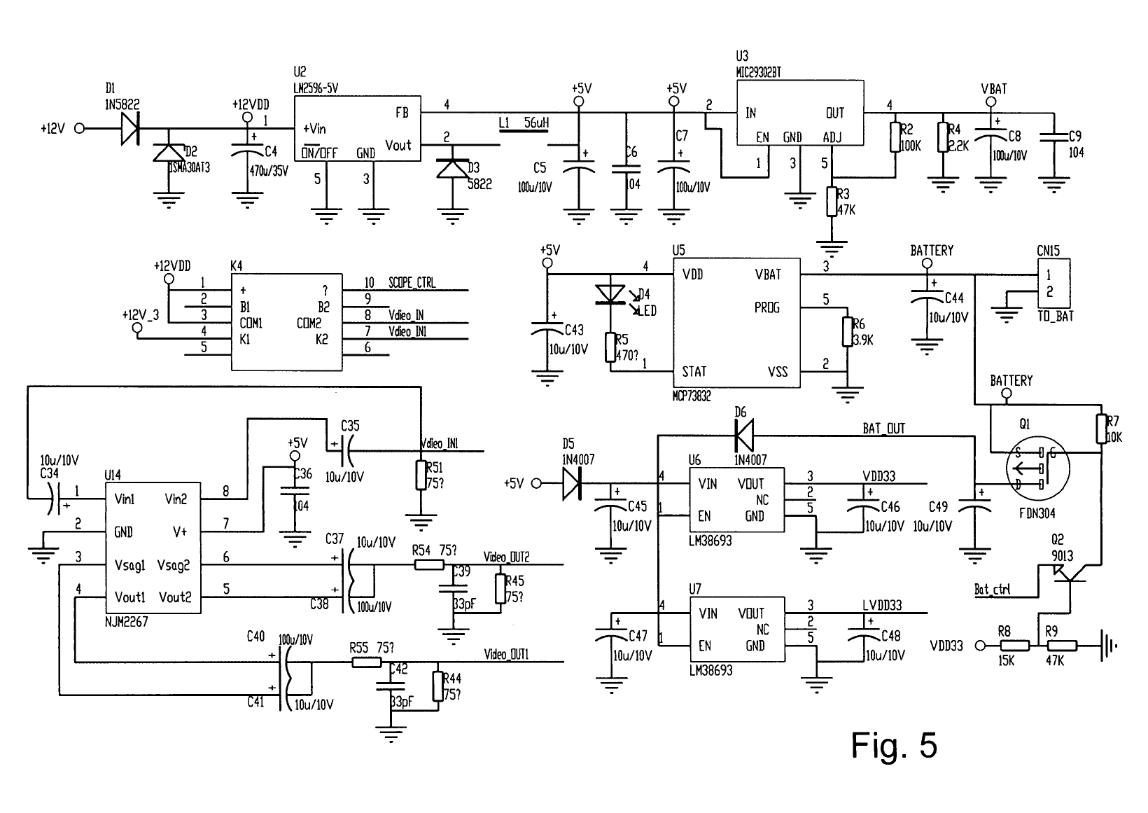

According to FIG. 1, all outside modules connect with outside baseboard 6, and endoscope 7 inputs the video signal to outside baseboard 6. In FIGS. 4 and 5, the chip signal input by endoscope 7 will be enlarged and divided to two, with one output to 12″ LCD 8, and another output to 7113 video converting chip 2 on the ARM core-board. The video analog signal is converted to digital signal by the 7113 video converting chip 2. When the digital video signal enters the S3C2440 main chip 1 then this allows a user to take photos or videos. The S3C2440 main chip 1 can connect with Bluetooth module 10, which can transmit the images to the computer for reception through 2.4G wireless communication.

The touchscreen 7″ LCD screen 9 is connected to the S3C2440 main chip 1 on ARM board through 40 Pin and 4 Pin FPC converted by outside baseboard 6. The related operating interface will be displayed onto preferably a 7″ LCD 9 after system start-up. A customer can control the content on the 7″ LCD 9 by pressing the control buttons, which is controlled by S3C2440 main chip 1. S3C2440 main chip 1 controls the output and receives input from the control buttons.

FIGS. 4 and 5 show that the outside baseboard 6 has GPRD module 11. GPRD module 11 connects with S3C2440 main chip 1 by serial port, and connects with the control center by wireless connection. When the equipment is starting up, the center will transmit the signal by wireless communication to GPRS module 11. The GPRS module 11 will transmit the data to a S3C2440 main chip through a serial port. The S3C2440 main chip 1 will receive the image data and then store it to the NAND FLASH memory chip 4.

1. This is a kind of automobile fuel/intake/catalytic system test equipment, including endoscope kit, 20″ LCD screen. The endoscope output CVBS single to 12″ LCD, through which we can clearly observe the selected images by endoscope. The images can be transmitted to 4S reception by Bluetooth module and printed out easily. The equipment includes 1 piece touchable 7″ LCD screen, from which we can get the standard images for fuel/intake/catalytic system. By comparison, we can find the carbon deposition conditions in the related area. The GPRD module on the equipment can transmit the image to equipment, to update and upload the new standard images.

2. The S3C2440 ARM main chip is applied on the equipment circuit board, with operating system Windows CE5.0. The 7″ LCD touchable screen is connected with S3C2440 touchable screen controlling joint by 4 PIN FPC and connected with the LCD controlling joint with 40 Pin FPC. The videos and images that endoscope gathered will be transformed to digital signal converted by video switch chip 7113, and then connecting with S3C2440. S3C2440 will control 7113 by IIC port to realize image capture. The Bluetooth module is connecting the USB Host port of S3C2440. Add the module concerning about the Bluetooth during operation system compiling, realize the functions such as research, match, transfer, and etc by API function in the software. The GPRS module is connecting with S3C2440 by serial port. Compile software to transmit the serial port data to GPRS module by S3C2440, proceeding the port configuration, data communication, GPRS image data, and etc.

3. The implement method of the test function includes below steps:
a. Switch on the equipment, the software will automatically run, while the background will connect the GPRS, search whether there's new standard images, and download if there's any.
b. After the application program runs, enter into the vehicle model selection interface, select the vehicle brand, model and manufacturing year. Then the standard image interface will come out. Standard images of different areas can be selected such as standard images on top of the piston for fuel system test, throttle body for intake system test. All these standard images will be displayed onto the 7″ LCD screen.
c. Place the endoscope to the testing place then its image will be showed onto 12″ LCD screen. The carbon deposition conditions image and standard image will be showed onto two screens.
d. Click “Transmit image’ on 7” LCD, then the system will match the Bluetooth, and transmit the images to computer with Bluetooth in 4S reception. Then the test image and standard images can be print out.
